(19) United States
(12) Patent Application Publication
(10) Pub. No.: US 2024/0058791 A1
(43) Pub. Date: Feb. 22, 2024

(54) PLATINUM GROUP METAL CATALYST COMPOSITION FOR TWC APPLICATION

(71) Applicant: BASF Corporation, Florham Park, NJ (US)

(72) Inventors: Shiang Sung, Iselin, NJ (US); Andreas Sundermann, Heidelberg (DE); Xiaolai Zheng, Iselin, NJ (US)

(21) Appl. No.: 18/267,510

(22) PCT Filed: Dec. 16, 2021
(86) PCT No.: PCT/EP2021/086117

§ 371 Date: Jun. 15, 2023

(30) Foreign Application Priority Data
Dec. 16, 2020 (EP) 20214695.7

(51) Int. Cl. B01J 23/63; B01J 35/00; B01J 37/10; B01J 37/00; B01D 53/94; B01J 35/04; B01J 23/42; B01J 23/46; B01J 23/44; B01J 37/02; F01N 3/10; F01N 3/28

(52) U.S. Cl. CPC B01J 23/63; B01J 35/0006; B01J 37/10; B01J 37/0018; B01D 53/945; B01J 35/04; B01J 23/42; B01J 23/464; B01J 23/44; B01J 37/0244; B01J 37/0201; B01J 37/0248; F01N 3/101; F01N 3/2828; B01D 2257/502; B01D 2257/702; B01D 2257/404; B01D 2255/1021; B01D 2255/1025; B01D 2255/407; B01D 2255/908; B01D 2258/014; B01D 2255/9155; B01D 2255/1023; F01N 2370/02

(57) ABSTRACT

The present invention provides a catalyst composition comprising at least one platinum group metal; and at least one complex metal oxide wherein the at least one platinum group metal is supported on the at least complex metal oxide, wherein the complex metal oxide comprises ceria (calculated as CeO₂) in an amount of about 50 to about 99 wt. %, based on the total weight of the complex metal oxide; and zirconia (calculated as ZrO₂) in an amount of about 1.0 to about 50 wt. %, based on the total weight the complex metal oxide. The present invention also provides a catalytic article made from said catalyst composition, its preparation and use for the treatment of the exhaust gases.

### FIELD OF THE INVENTION

The presently claimed invention relates to a catalyst composition useful for the treatment of the exhaust gases to reduce contaminants contained therein. Particularly, the presently claimed invention relates to a platinum group metal-based catalyst composition.

### BACKGROUND OF THE INVENTION

Pd/Rh three-way conversion (TWC) catalysts have been the major force in meeting the tighter regulations worldwide for gasoline vehicles, mainly due to their good synergism with oxygen storage components (OSCs) to cover both cold-start light-off (L/O) and tight lambda-swing (including fuel-cut) requirements.

However, as Pd is becoming increasingly scarce, and the price of Pd is going ever higher, the OEMs have begun to ask the catalyst suppliers to provide Pt-containing TWCs.

Unfortunately, the ingredients used in the Pd/Rh TWC technology are not suitable for Platinum (Pt), hence the simple replacement of Pd with Pt has not yet worked in an expected way. One of the reasons is lack of synergism of OSCs with Pt, under the lean-rich lambda perturbation conditions typically encountered in the gasoline vehicle operations, particularly at low temperatures (i.e. cold start and idle periods).

Accordingly, the presently claimed invention is focused on solving the aforesaid problem associated with the support and platinum group metals such as Platinum.

One of the main objects of the presently claimed invention is to energize Pt-OSC synergism by developing a new class of OSCs.

### SUMMARY OF THE INVENTION

The presently claimed invention provides a catalyst composition comprising:
a. at least one platinum group metal; and
b. at least one complex metal oxide,
   wherein the at least one platinum group metal is supported on the complex metal oxide, wherein the complex metal oxide comprises:
i) ceria (calculated as CeO₂) in an amount of about 50 to about 99 wt. %, based on the total weight of the complex metal oxide; and
ii) zirconia (calculated as ZrO₂) in an amount of about 1.0 to about 50 wt. %, based on the total weight of the complex metal oxide.
   The presently claimed invention also provides a catalytic article comprising the catalyst composition according to the presently claimed invention; and a substrate, wherein the catalyst composition is deposited on the substrate.

### BRIEF DESCRIPTION OF THE DRAWINGS

In order to provide an understanding of the embodiments of the invention, reference is made to the appended drawings, which are not necessarily drawn to scale, and in which reference numerals refer to components of exemplary embodiments of the invention. The drawings are exemplary only and should not be construed as limiting the invention. The above and other features of the presently claimed invention, their nature, and various advantages will become more apparent upon consideration of the following detailed description, taken in conjunction with the accompanying drawings:

FIG. 1 illustrates comparative FTP 72 results from the dynamic reactor simulating a 2.7 L engine, with a FC+RC catalyst system, wherein I: engine aged front catalyst only (FC); II: FC with a reference Pd/Rh rear catalyst; III: FC with a reference Pt/Rh rear catalyst; and IV: FC with an inventive Pt/Rh rear catalyst.

FIG. 2 illustrates comparative NO reduction during the cold start period.

FIG. 3 illustrates the engine calibration pre-set lambda values during the FTP first 1400 seconds (Bag 1+Bag 2).

FIG. 4A is a perspective view of a honeycomb-type substrate carrier which may comprise the catalyst composition in accordance with one embodiment of the presently claimed invention.

FIG. 4B is a partial cross-section view enlarged relative to FIG. 4A and taken along a plane parallel to the end faces of the substrate carrier of FIG. 4A, which shows an enlarged view of a plurality of the gas flow passages shown in FIG. 4A.

FIG. 5 is a cutaway view of a section enlarged relative to FIG. 4A, wherein the honeycomb-type substrate in FIG. 4A represents a wall flow filter substrate monolith.

### DETAILED DESCRIPTION

The presently claimed invention now will be described more fully hereafter. The presently claimed invention may be embodied in many different forms and should not be construed as limited to the embodiments set forth herein; rather, these embodiments are provided so that this presently claimed invention will be thorough and complete, and will fully convey the scope of the invention to those skilled in the art. No language in the specification should be construed as indicating any non-claimed element as essential to the practice of the disclosed materials and methods.

All methods described herein can be performed in any suitable order unless otherwise indicated herein or otherwise clearly contradicted by context. The use of any and all examples, or exemplary language (e.g., “such as”) provided herein, is intended merely to better illustrate the materials and methods and does not pose a limitation on the scope unless otherwise claimed.

### Definitions

The use of the terms “a”, “an”, “the”, and similar referents in the context of describing the materials and methods discussed herein (especially in the context of the following claims) are to be construed to cover both the singular and the plural, unless otherwise indicated herein or clearly contradicted by context.

The term “about” used throughout this specification is used to describe and account for small fluctuations. For example, the term “about” refers to less than or equal to ±5%, such as less than or equal to ±2%, less than or equal to ±1%, less than or equal to +0.5%, less than or equal to ±0.2%, less than or equal to ±0.1% or less than or equal to ±0.05%. All numeric values herein are modified by the term “about,” whether or not explicitly indicated. A value modified by the term “about” of course includes the specific value. For instance, “about 5.0” must include 5.0.

In the context of the present invention the term “first layer” is interchangeably used for “bottom layer” or“bottom coat”, whereas the term “second layer” is interchangeably used for “top layer” or “top coat”. The first layer is deposited at least on a part of the substrate and the second layer is deposited on at least on part of the first layer.

The term “catalyst” or “catalytic article” or “catalyst article” refers to a component in which a substrate is coated with a catalyst composition which is used to promote a desired reaction. The catalytic article can be a layered catalytic article. The term layered catalytic article refers to a catalytic article in which a substrate is coated with a catalyst composition(s) in a layered fashion. These catalytic composition(s) may be referred to as washcoat(s). The catalyst composition comprises at least one PGM as catalytically active metal.

Platinum group metals, also referred to as “PGM” are ruthenium, rhodium, palladium, osmium, iridium and platinum.

The term “three-way conversion catalyst” refers to a catalyst that simultaneously promotes a) reduction of nitrogen oxides to nitrogen and oxygen; b) oxidation of carbon monoxide to carbon dioxide; and c) oxidation of unburnt hydrocarbons to carbon dioxide and water.

The term “NOx” refers to nitrogen oxide compounds, such as NO and/or NO₂.

A “support” refers to a material to which metals (e.g., PGMs), stabilizers, promoters, binders, and the like are affixed through precipitation, association, dispersion, impregnation, or other suitable methods.

The term “deposited” and “supported” are used interchangeably. Deposition of the catalytically active metal on the support can be achieved by various methods known to the person skilled in the art. These include coating techniques, impregnation techniques like incipient wetness impregnation, precipitation techniques as well as atomic deposition techniques like chemporousical vapour deposition. In these techniques a suitable precursor comprising the catalytically active metal is brought into contact with the support and thereby undergoes chemical or physical bonding with the support. The catalytically active metal is thus deposited on the support. Upon interaction with the support, the precursor comprising the catalytically active metal may be transformed to another species comprising the catalytically active metal. To increase the chemical or physical bonding of the deposited species with the support, different treatment steps like chemical fixing and/or thermal fixing can be performed.

The term “thermal fixing” refers to deposition of the catalytically active metal onto the respective support, e.g. via incipient wetness impregnation method, followed by the thermal calcination of the resulting catalytically active metal/support mixture. In one embodiment, the mixture is calcined for 1.0 to 3.0 hours at 400-700° C. with a ramp rate of 1-25° C./min.

The term “chemical fixing” refers to deposition of the catalytically active metal onto the respective support followed by a fixation using an additional reagent such as Ba-hydroxide to chemically transform the precursor comprising the catalytically active metal. As a result, catalytically active metal is chemically fixed as an insoluble component in the pores and on the surface of the support.

The term hydrothermal stability of a catalyst may be functionally defined as retaining enough catalytic function after a high temperature aging. Specifically in this context, hydrothermal stability means that after an aging treatment at a temperature ranging from 950° C. to 1050° C. for about 5 hours with 10% steam a catalyst should have a CO/NOx light-off temperature (T50) lower than 400° C. and a hydrocarbon light-off temperature (T70) lower than 290° C. 400° C., for a PGM loading (Pt) at 0.5%.

As used herein, the term “single layer” refers to a washcoat deposited on the substrate as a one layer. As used herein, the term “bi layered” refers to two washcoats deposited on the substrate as separate layers. It consists of a first layer which is deposited as a bottom coat on the substrate and a second layer which is deposited as a top coat on the first layer and/or on parts of the substrate.

The term “incipient wetness impregnation” also known as capillary impregnation or dry impregnation refers to dissolving a precursor of the catalytically active metal into an aqueous or organic solution and adding the resultant catalytically active metal containing solution to support. The capillary action draws the solution into the pores of the support. The composition obtained is dried and calcined to remove the volatile components within the solution, depositing the metal on the surface of the support.

As used herein, the term “substrate” refers to a material onto which the catalyst composition is placed, typically in the form of a washcoat. The substrate is sufficiently porous to permit the passage of the gas stream being treated.

Reference to “monolithic substrate” or “honeycomb substrate” means a unitary structure that is homogeneous and continuous from inlet to outlet.

As used herein, the term “washcoat” has its usual meaning in the art of a thin, adherent coating of a catalytic or other material, like a catalyst composition, applied to a substrate, such as a honeycomb-type substrate. A washcoat is formed by preparing a slurry containing a certain solid content (e.g., 15-60% by weight of the slurry) of particles in a liquid vehicle, which is then coated onto a substrate and dried to provide a washcoat layer.

As used herein, “refractory metal oxide” refers to a metal-containing oxide exhibiting high chemical and physical stability at high temperatures, such as the temperatures associated with gasoline and diesel engine exhaust. The stability can be represented, for example, by the surface area measurements as square meters per gram of the sample. High stability therefore refers to the change of surface area after the high temperature exposure (>800° C.), is less than 50% of the original values (before the high temperature exposure).

“BET surface area” has its usual meaning of referring to the Brunauer, Emmett, Teller method for determining surface area by N2 adsorption.

The term “oxygen storage component” (OSC) refers to an entity that has a multi-valence state and can actively react with reductants such as carbon monoxide (CO) and/or hydrogen under reduction conditions and then react with oxidants such as oxygen or nitrogen oxides under oxidative conditions.

OSC in the present context refers to ceria-zirconia. In one preferred embodiment, OSC refers to ceria-zirconia essentially stabilized by at least one additional rare earth element, such as lanthanum, yttrium, neodymium, and praseodymium, which may be present in oxide form.

As used herein, the term “stream” broadly refers to any combination of flowing gas that may contain solid or liquid particulate matter.

As used herein, the terms “upstream” and “downstream” refer to relative directions according to the flow of an engine exhaust gas stream from an engine towards a tailpipe, with the engine in an upstream location and the tailpipe and any pollution abatement articles such as filters and catalysts being downstream from the engine.

The object of the presently claimed invention i.e. energizing Pt-OSC synergism is achieved by using a catalyst composition containing OSCs with high Ce content (>50% of the total weight of OSC) which can be used to activate Pt-OSC function in order to achieve the hydrocarbon (HC) light-off property comparable to Pd-OSC and improve Rh-OSC function.

Catalyst Composition:

Accordingly, the presently claimed invention in a first aspect provides a catalyst composition comprising:
a) at least one platinum group metal; and
b) at least one complex metal oxide,
wherein the platinum group metal is supported on the complex metal oxide,
wherein the complex metal oxide comprises:
i) ceria (calculated as CeO₂) in an amount of about 50 to about 99 wt. %, based on the total weight of the complex metal oxide; and
ii) zirconia (calculated as ZrO₂) in an amount of about 1.0 to about 50 wt. %, based on the total weight of the complex metal oxide.

### Platinum Group Metals:

Platinum group metals, also referred to as “PGM” are ruthenium, rhodium, palladium, osmium, iridium and platinum. Preferably, the platinum group metal is selected from platinum, rhodium, palladium and a combination thereof. In a preferred embodiment, the platinum group metal is platinum. In another preferred embodiment, the platinum group metal is palladium. In still another preferred embodiment, the platinum group metal is rhodium.

Preferably, the total amount of the platinum group metal supported on the complex metal oxide is in the range from 0.1 to 10 wt. % with respect to the total weight of the complex metal oxide. More preferably, the total amount of the platinum group metal supported on the complex metal oxide is in the range from 0.1 to 5.0 wt. % with respect to the total weight of the complex metal oxide.

### Support Materials:

A. Complex Metal Oxide

In the context of the present invention, the support material used for supporting the platinum group metal is a complex metal oxide comprising ceria and zirconia in a specific proportion.

The term complex metal oxide refers to a metal oxide that contains oxygen and at least two different metal cations. In a complex oxide, the different metal cations and oxygen are incorporated into one crystal structure. Preferably, the complex metal oxide has a single phase of cubic fluorite crystal structure.

Preferably, ceria (calculated as CeO₂) is present in an amount of 50 to 99 wt. %, based on the total weight of the complex metal oxide and zirconia (calculated as ZrO₂) is present in an amount of 1.0 to 50 wt. %, based on the total weight of the complex metal oxide.

More preferably, ceria (calculated as CeO₂) is present in an amount of 50 to 95 wt. %, based on the total weight of the complex metal oxide and zirconia (calculated as ZrO₂) is present in an amount of 5.0 to 50 wt. %, based on the total weight of the complex metal oxide.

Most preferably, the complex metal oxide comprises ceria (calculated as CeO₂) in an amount of 70 wt. %, based on the total weight of the complex metal oxide component and zirconia (calculated as ZrO₂) in an amount of 30 wt. %, based on the total weight of complex metal oxide component.

Preferably, the complex metal oxide comprises a dopant selected from, lanthana, titania, hafnia, magnesia, calcia, strontia, baria, yttrium, hafnium, praseodymium, neodymium or any combinations thereof. The dopant metal may be incorporated in a cationic form into the crystal structure of the complex metal oxide, may be deposited in an oxidic form on the surface of the complex metal oxide, or may be present in the oxidic form as a blend of mixtures of both dopants and complex metal oxide on a micro-scale.

Preferably, the complex metal oxide has an oxygen storage capacity of at least 150 μmole at about 350° C., and at least 300 μmole at about 450° C., after a lean and rich aging at a temperature above at least 900° C., wherein the amount of the platinum group metal supported on the complex metal oxide is about 0.1 wt. % to 10 wt. %, based on the total weight of the complex metal oxide, wherein the platinum group metal is platinum or palladium. More preferably, the complex metal oxide has an oxygen storage capacity is in the range of 150 to 500 μmole at about 350 to about 450° C. after a lean and rich aging at a temperature 900° C. to 1200° C., preferably above at least 900° C., wherein the amount of the platinum group metal supported on the complex metal oxide is at least about 0.1 wt. % to 10 wt. %, based on the total weight of the complex metal oxide, wherein the platinum group metal is rhodium.

Most preferably, the complex metal oxide has an oxygen storage capacity greater than 400 μmole at 450° C. after a lean and rich aging at a temperature greater than 950° C., wherein the amount of platinum supported on the complex metal oxide is about above 0.1%, based on the total weight of the complex metal oxide.

Most preferably, the complex metal oxide has an oxygen storage capacity greater than 300 μmole at 450° C. after a lean and rich aging at a temperature greater than 950° C., wherein the amount of platinum supported on the complex metal oxide is about above 0.5%, based on the total weight of the complex metal oxide.

Most preferably, the complex metal oxide has an oxygen storage capacity greater than 200 μmole at 350° C. after a lean and rich aging at a temperature greater than 950° C., wherein the amount of platinum or palladium supported on the complex metal oxide is about above 0.5%, based on the total weight of the complex metal oxide.

Most preferably, the complex metal oxide has an oxygen storage capacity greater than 150 μmole at 350° C. after a lean and rich aging at a temperature greater than 950° C., wherein the amount of rhodium supported on the complex metal oxide is about above 0.1%, based on the total weight of the complex metal oxide.

The total amount of complex metal oxide including the thereon supported PGMs in the catalyst composition is preferably in the range of 50 to 100 wt. %, based on the total weight of the catalyst composition.

### Refractory Metal Oxide:

Preferably, the catalyst composition comprises at least one refractory metal oxide different from the complex metal oxide. In general, refractory metal oxides include alumina, silica, zirconia, titania, and physical mixtures or chemical mixtures thereof, including atomically doped combinations. The refractory metal oxide is used as an additional support material for platinum group metals. The refractory metal oxide can be a high surface area refractory metal oxide which refer specifically to support particles having pores larger than 20 Å and a wide pore distribution. In one embodiment, additional platinum group metals can be supported on the refractory metal oxide. The platinum group metal supported on the refractory metal oxide can be different than the platinum group metal supported on the complex metal oxide.

The amount of platinum group metal supported on the refractory metal oxide is preferably in the range of 0.1 to 10 wt. % based on the weight of the refractory metal oxide.

The total amount of refractory metal oxide including the thereon supported PGMs in the catalyst composition is preferably in the range of 0.1 to 50 wt. %, based on the total weight of the catalyst composition.

Preferably, the refractory metal oxide used is an alumina. The term “alumina” refers to stabilized or non-stabilized aluminium oxide. Stabilized aluminium oxide and non-stabilized aluminium oxide can be present in different phase modifications.

Stabilized aluminium oxide comprises Al₂O₃ and one or more dopants selected from rare earth metal oxides, alkaline metal oxides, alkaline earth metal oxides, silicon dioxide or any combination of the aforementioned. Preferable dopants are lanthanum oxide (La₂O₃), cerium oxide (CeO₂), zirconium oxide (ZrO₂), barium oxide BaO), neodymium oxide (Nd₂O₃), strontium oxide (SrO), combinations of lanthanum oxide and zirconium oxide, combinations of barium oxide and lanthanum oxide, combinations of barium oxide, lanthanum oxide and neodymium oxide or combinations of cerium oxide and zirconium oxide. The dopants can impart different properties on the aluminium oxide. The dopants can retard undesired phase transformations of the aluminium oxide, can stabilize the surface area, can introduce defect sites and/or change the acidity of the aluminium oxide surface. The dopant metal may be incorporated in cationic form into the crystal structure of Al₂O₃ to form a complex oxide, may be deposited in oxidic form on the surface of the Al₂O₃, or may be present in oxidic form as blend of mixtures of both dopants and Al₂O₃ on a micro-scale.

Exemplary stabilized and non-stabilized alumina may include large pore boehmite, gamma-alumina, and delta/theta alumina. Useful commercial alumina includes activated alumina(s), such as high bulk density gamma-alumina, low or medium bulk density large pore gamma-alumina, and low bulk density large pore boehmite and gamma-alumina. Such materials are generally considered as providing durability to the resulting catalyst. High surface area alumina supports, also referred to as “gamma alumina” or “activated alumina,” typically exhibit a BET surface area of fresh material in excess of 60 square meters per gram (“m²/g”), often up to about 300 m²/g or higher. Such activated alumina is usually a mixture of the gamma and delta phases of alumina, but may also contain substantial amounts of eta, kappa and theta alumina phases.

Preferably, the BET surface area of alumina ranges from about 100 to about 150 m²/g.

### Preparation of the Catalyst Composition:

In accordance with another aspect of the presently claimed invention there is also provided a process for the preparation of a catalyst composition according to any of the embodiments described herein above. The process comprises preparing a slurry comprising a platinum group metal supported on the complex metal oxide and optionally on a refractory metal oxide support, water, a pH control agent and a binder; and calcining the slurry at a temperature ranging from 400 to 700° C. to obtain the catalyst composition, wherein the step of preparing the slurry comprises a technique selected from incipient wetness impregnation, incipient wetness co-impregnation, and post-addition to support the platinum group metal on the complex metal oxide.

### Excipients:

### pH Control Agent:

The pH controlling agent used for maintaining the pH of the slurry in the range of 1.0 to 6.0 is selected from carboxylic acid, acetic acid, nitric acid, sulfuric acid, ammonia hydroxide or any combinations thereof.

### Binder:

The binder is selected from surfactants, colloidal powders made from alumina; zirconia; silica; and titania, and polymers.

### Catalytic Article:

In accordance with another aspect of the presently claimed invention there is also provided a catalytic article comprising the catalyst composition according to the presently claimed invention deposited on a substrate.

Preferably, the catalytic article comprises:
a) a catalyst composition; and
b) a substrate,
wherein the catalyst composition is deposited on at least parts of the substrate,
wherein the catalyst composition comprises at least one platinum group metal; and at least one complex metal oxide, wherein the at least one platinum group metal is supported on the complex metal oxide, wherein the complex metal oxide comprises ceria (calculated as CeO₂) in an amount of 50 to 99 wt. %, based on the total weight of the complex metal oxide; and zirconia (calculated as ZrO₂) in an amount of 1.0 to 50 wt. %, based on the total weight of the complex metal oxide.

### Substrate:

The substrate of the catalytic article of the presently claimed invention may be constructed of any material typically used for preparing automotive catalysts. In a preferred embodiment, the substrate is a ceramic substrate, metal substrate, ceramic foam substrate, polymer foam substrate or a woven fiber substrate. In one embodiment, the substrate is a ceramic or a metal monolithic honeycomb structure.

The substrate provides a plurality of wall surfaces upon which washcoats comprising the catalyst compositions described herein above are applied and adhered, thereby acting as a carrier for the catalyst compositions.

Preferable metallic substrates include heat resistant metals and metal alloys such as titanium and stainless steel as well as other alloys in which iron is a substantial or major component. Such alloys may contain one or more nickel, chromium, and/or aluminium, and the total amount of these metals may advantageously comprise at least 15 wt. % of the alloy. e.g. 10-25 wt. % of chromium, 3-8% of aluminium, and up to 20 wt. % of nickel. The alloys may also contain small or trace amounts of one or more metals such as manganese, copper, vanadium, titanium and the like. The surface of the metal substrate may be oxidized at high temperature, e.g., 1000° C. and higher, to form an oxide layer on the surface of the substrate, improving the corrosion resistance of the alloy and facilitating adhesion of the washcoat layer to the metal surface.

Preferable ceramic materials used to construct the substrate may include any suitable refractory material, e.g., cordierite, mullite, cordierite-alumina, silicon nitride, zircon mullite, spodumene, alumina-silica magnesia, zircon silicate, sillimanite, magnesium silicates, zircon, petalite, alumina, aluminosilicates and the like.

Any suitable substrate may be employed, such as a monolithic flow-through substrate having a plurality of fine, parallel gas flow passages extending from an inlet to an outlet face of the substrate such that passages are open to fluid flow. The passages, which are essentially straight paths from the inlet to the outlet, are defined by walls on which the catalytic material is coated as a washcoat so that the gases flowing through the passages contact the catalytic material. The flow passages of the monolithic substrate are thin-walled channels which are of any suitable cross-sectional shape, such as trapezoidal, rectangular, square, sinusoidal, hexagonal, oval, circular, and the like. Such structures contain from about 60 to about 1200 or more gas inlet openings (i.e., “cells”) per square inch of cross section (cpsi), more usually from about 300 to 900 cpsi. The wall thickness of flow-through substrates can vary, with a typical range being between 0.002 and 0.1 inches. A representative commercially available flow-through substrate is a cordierite substrate having 400 cpsi and a wall thickness of 6 mil, or 600 cpsi and a wall thickness of 4 mil. However, it will be understood that the invention is not limited to a particular substrate type, material, or geometry. In alternative embodiments, the substrate may be a wall-flow substrate, wherein each passage is blocked at one end of the substrate body with a non-porous plug, with alternate passages blocked at opposite end-faces. This requires that gas flow through the porous walls of the wall-flow substrate to reach the exit. Such monolithic substrates may contain up to about 700 or more cpsi, such as about 100 to 400 cpsi and more typically about 200 to about 300 cpsi. The cross-sectional shape of the cells can vary as described above. Wall-flow substrates typically have a wall thickness between 0.002 and 0.1 inches. A representative commercially available wall-flow substrate is constructed from a porous cordierite, an example of which has 200 cpsi and 10 mil wall thickness or 300 cpsi with 8 mil wall thickness, and wall porosity between 45-65%. Other ceramic materials such as aluminum-titanate, silicon carbide and silicon nitride are also used as wall-flow filter substrates. However, it will be understood that the invention is not limited to a particular substrate type, material, or geometry. Note that where the substrate is a wall-flow substrate, the catalyst composition can permeate into the pore structure of the porous walls (i.e., partially or fully occluding the pore openings) in addition to being disposed on the surface of the walls. In one embodiment, the substrate has a flow through ceramic honeycomb structure, a wall-flow ceramic honeycomb structure, or a metal honeycomb structure.

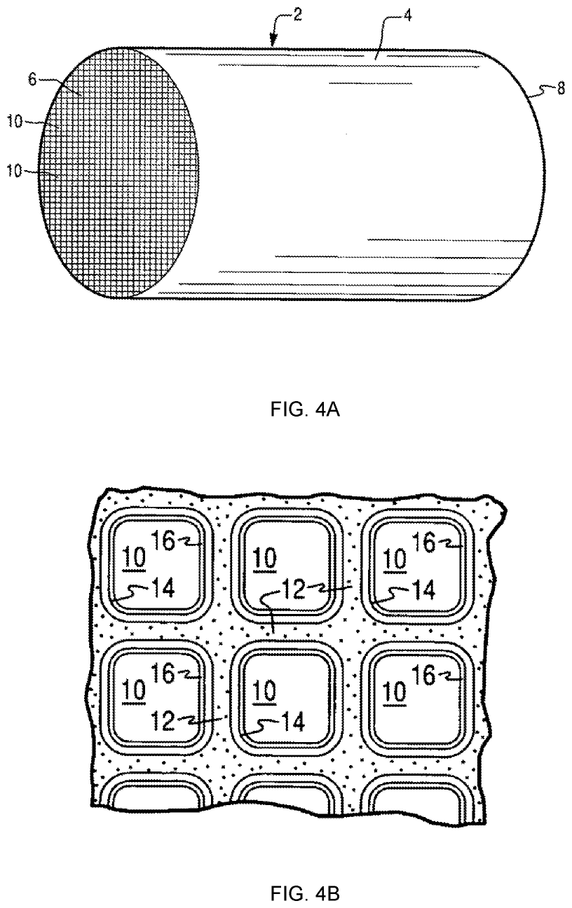

FIGS. 4A and 4B illustrate an exemplary substrate 2 in the form of a flow-through substrate coated with washcoat compositions as described herein. Referring to FIG. 4A, the exemplary substrate 2 has a cylindrical shape and a cylindrical outer surface 4, an upstream end face 6 and a corresponding downstream end face 8, which is identical to end face 6. Substrate 2 has a plurality of fine, parallel gas flow passages 10 formed therein. As seen in FIG. 4B, flow passages 10 are formed by walls 12 and extend through substrate 2 from upstream end face 6 to downstream end face 8, the passages 10 being unobstructed so as to permit the flow of a fluid, e.g., a gas stream, longitudinally through substrate 2 via gas flow passages 10 thereof. As more easily seen in FIG. 4B, walls 12 are so dimensioned and configured that gas flow passages 10 have a substantially regular polygonal shape. As shown, the washcoat compositions can be applied in multiple, distinct layers if desired. In the illustrated embodiment, the washcoats consist of a discrete first washcoat layer 14 adhered to the walls 12 of the substrate member and a second discrete washcoat layer 16 coated over the first washcoat layer 14. In one embodiment, the presently claimed invention is also practiced with two or more (e.g., 3, or 4) washcoat layers and is not limited to the illustrated two-layer embodiment.

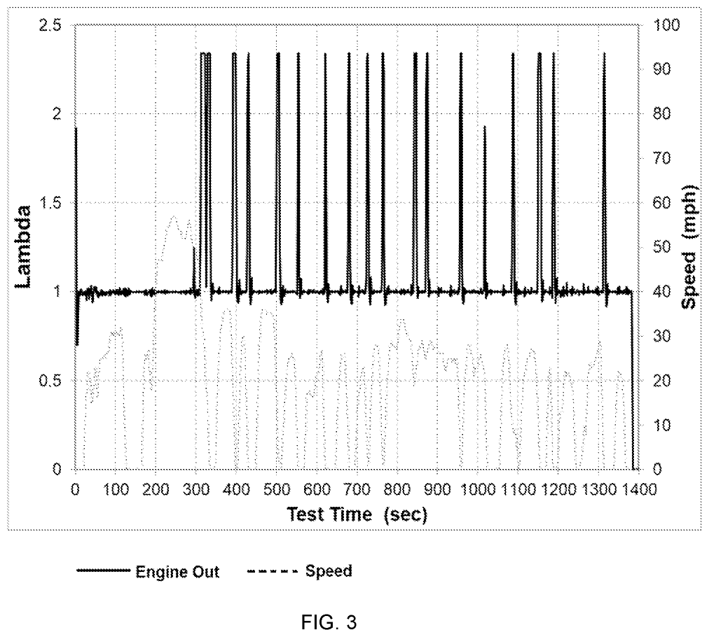

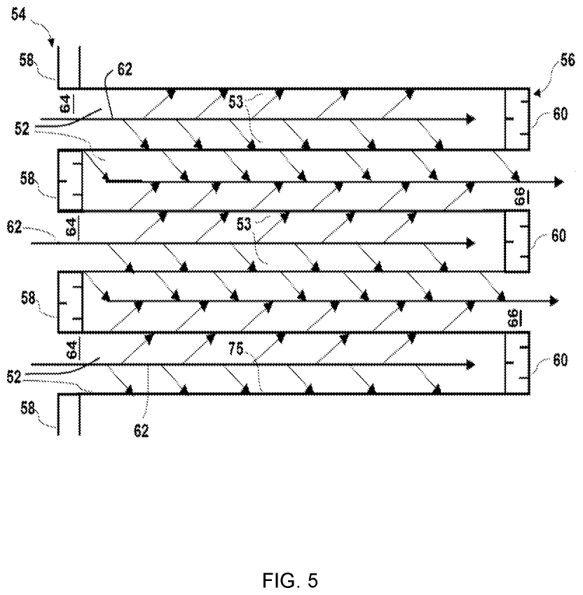

FIG. 5 illustrates an exemplary substrate 2 in the form of a wall flow filter substrate coated with a washcoat composition as described herein. As seen in FIG. 3, the exemplary substrate 2 has a plurality of passages 52. The passages are tubularly enclosed by the internal walls 53 of the filter substrate. The substrate has an inlet end 54 and an outlet end 56. Alternate passages are plugged at the inlet end with inlet plugs 58 and at the outlet end with outlet plugs 60 to form opposing checkerboard patterns at the inlet 54 and outlet 56. A gas stream 62 enters through the unplugged channel inlet 64, is stopped by outlet plug 60 and diffuses through channel walls 53 (which are porous) to the outlet side 66. The gas cannot pass back to the inlet side of walls because of inlet plugs 58. The porous wall flow filter used in this invention is catalysed in that the wall of said element has thereon or contained therein one or more catalytic materials. Catalytic materials may be present on the inlet side of the element wall alone, the outlet side alone, both the inlet and outlet sides, or the wall itself may consist all, or in part, of the catalytic material. This invention includes the use of one or more layers of catalytic material on the inlet and/or outlet walls of the element.

### Washcoat/s or Layer/s on Substrate:

The catalyst composition according to the presently claimed invention is preferably deposited on at least portion of the substrate as a single layer (single washcoat) to obtain a single layered catalytic article. The composition preferably comprises at least one platinum group metal; and at least one complex metal oxide, wherein the platinum group metal is supported on the complex metal oxide and wherein the complex metal oxide comprises ceria (calculated as CeO₂); and zirconia. Preferably, the total amount of the platinum group metal supported on the complex metal oxide is in the range from 0.1 to 10 wt. % with respect to the total weight of the complex metal oxide. More preferably, the total amount of the platinum group metal supported on the complex metal oxide is in the range from 0.1 to 5.0 wt. % with respect to the total weight of the complex metal oxide. Preferably, ceria (calculated as CeO₂) is present in an amount of 50 to 99 wt. %, based on the total weight of the complex metal oxide and zirconia (calculated as ZrO₂) is present in an amount of 1.0 to 50 wt. %, based on the total weight of the complex metal oxide. More preferably, ceria (calculated as CeO₂) is present in an amount of 50 to 95 wt. %, based on the total weight of the complex metal oxide and zirconia (calculated as ZrO₂) is present in an amount of 5.0 to 50 wt. %, based on the total weight of the complex metal oxide. Most preferably, the complex metal oxide comprises ceria (calculated as CeO₂) in an amount of 70 wt. %, based on the total weight of the complex metal oxide component and zirconia (calculated as ZrO₂) in an amount of 30 wt. %, based on the total weight of complex metal oxide component.

Preferably, the washcoat covers 90 to 100% of the surface of the substrate. More preferably, the washcoat covers 95 to 100% of the surface of the substrate and even more preferably, the washcoat covers the whole accessible surface of the substrate. The term “accessible surface” refers to the surface of the substrate which can be covered with the conventional coating techniques used in the field of catalyst preparation like impregnation techniques.

The catalyst composition according to the presently claimed invention is preferably deposited on the substrate as a single layer (single washcoat).

Preferably, the single layered catalytic article exhibits hydrothermal stability at an aging temperature above 900° C.

Preferably, the washcoat comprises a zoned configuration, wherein the zoned configuration comprises a first zone, a second zone, a third zone or a combination thereof. The first zone and/or second zone and/or third zone comprises the catalyst composition according to the presently claimed invention.

Preferably, the first zone comprises platinum group metal supported on a complex metal oxide. Preferably, the second zone comprises platinum group metal supported on a complex metal oxide. Preferably, the complex metal oxide comprises ceria (calculated as CeO₂) in an amount of 50 to 99 wt. %, based on the total weight of the complex metal oxide; and zirconia (calculated as ZrO₂) in an amount of 1.0 to 50 wt. % %, based on the total weight of the complex metal oxide.

Preferably, the first zone and the second zone together cover 50 to 100% of length of the substrate. More preferably, the first and second zone together cover 90 to 100% of the length of the substrate and even more preferably, the first and the second zone together cover the whole length of the substrate.

Preferably, the first zone covers 10 to 90% of the entire substrate length from an inlet and the second zone covers 90 to 10% of the entire substrate length from an outlet, while the first zone and the second zone together cover 20 to 100% of the length of the substrate. More preferably, the first zone covers 20 to 80% of the entire substrate length from the inlet and the second zone covers 80 to 20% of the entire substrate length from the outlet, while the first zone and the second zone together cover 40 to 100% of the length of the substrate. Even more preferably, the first zone covers 30 to 70% of the entire substrate length from the inlet and the second zone covers 70 to 30% of the entire substrate length from the outlet, while the first zone and the second zone together cover 60 to 100% of the length of the substrate. Even most preferably, the first zone covers 40 to 50% of the entire substrate length from the inlet and the second zone covers 50 to 40% of the entire substrate length from the outlet, while the first zone and the second zone together cover 80 to 100% of the length of the substrate.

Preferably, the catalyst composition according to the presently claimed invention is deposited on the substrate as a first layer (bottom washcoat) which is further coated with a second layer (top washcoat) to obtain a bi-layered catalytic article.

Preferably, the first layer comprises platinum supported on a complex metal oxide. Preferably, the complex metal oxide comprises ceria (calculated as CeO₂) in an amount of 50 to 99 wt. %, based on the total weight of the complex metal oxide; and zirconia (calculated as ZrO₂) in an amount of 1.0 to 50 wt. % %, based on the total weight of the complex metal oxide.

Preferably, the second layer comprises rhodium supported on a complex metal oxide. The complex metal oxide comprises ceria (calculated as CeO₂) in an amount of 50 to 99 wt. %, based on the total weight of the complex metal oxide; and zirconia (calculated as ZrO₂) in an amount of 1.0 to 50 wt. % %, based on the total weight of the complex metal oxide.

Preferably, the catalytic article is a bi-layered article comprising a first layer; and a second layer, wherein the first layer is deposited on at least parts of the substrate and the second layer is deposited on at least parts of the first layer and/or at least on parts of the substrate, wherein the first layer comprises platinum and a complex metal oxide, wherein platinum is supported on the complex metal oxide, wherein the complex metal oxide comprises ceria (calculated as CeO₂) in an amount of 50 to 99 wt. %, based on the total weight of the complex metal oxide; and zirconia (calculated as ZrO₂) in an amount of 1.0 to 50 wt. % %, based on the total weight of the complex metal oxide, wherein the second layer comprises rhodium supported on a complex metal oxide, wherein the complex metal oxide comprises ceria (calculated as CeO₂) in an amount of 50 to 99 wt. %, based on the total weight of the complex metal oxide; and zirconia (calculated as ZrO₂) in an amount of 1.0 to 50 wt. % %, based on the total weight of the complex metal oxide.

Preferably, the first layer comprises a first zone and a second zone, wherein the first and/or the second zone comprises the catalyst composition according to the presently claimed invention.

Preferably, the second layer comprises a first zone and a second zone, wherein the first and/or the second zone comprises the catalyst composition according to the presently claimed invention.

Preferably, each of the first layer and second layer comprises a first zone and a second zone, wherein the first and/or the second zone comprises the catalyst composition according to the presently claimed invention.

### Preparation of Catalytic Article:

In another aspect of the present invention, there is also provided a process for the preparation of a single layered catalytic article described herein above, wherein said process comprises:
preparing a slurry comprising a platinum group metal supported on the complex metal oxide and optionally on a refractory metal oxide support, water, a pH control agent and a binder; and
depositing the slurry on the substrate followed by calcining at a temperature ranging from 400 to 700° C. to obtain the catalytic article.

There is also provided a process for the preparation of at least two-layered catalytic article according, wherein said process comprises:
preparing a first slurry comprising platinum or palladium supported on the complex metal oxide and optionally on a refractory metal oxide support, water, a pH control agent and a binder; and
depositing the first slurry on the substrate to obtain a first layer followed by calcining at a temperature ranging from 400 to 700° C.;
preparing a second slurry comprising rhodium supported on the complex metal oxide and optionally on a refractory metal oxide support, water, a pH control agent and a binder catalytic article; and
depositing the second slurry on the first layer to obtain a second layer followed by calcining at a temperature ranging from 400 to 700° C.

The process may involve a pre-step of thermal or chemical fixing of platinum or palladium or both on supports.

The preparation of catalytic article involves impregnating a support material in particulate form with an active metal solution, such as palladium, platinum/and or rhodium precursor solution. As used herein, “impregnated” or “impregnation” refers to permeation of the catalytic material into the porous structure of the support material. The techniques used to perform impregnation or preparing slurry include incipient wetness impregnation technique (A); co-precipitation technique (B) and co-impregnation technique (C).

Incipient wetness impregnation techniques, also called capillary impregnation or dry impregnation are commonly used for the synthesis of heterogeneous materials, i.e., catalysts. Typically, a metal precursor is dissolved in an aqueous or organic solution and then the metal-containing solution is added to a catalyst support containing the same pore volume as the volume of the solution that was added. Capillary action draws the solution into the pores of the support. Solution added in excess of the support pore volume causes the solution transport to change from a capillary action process to a diffusion process, which is much slower. The catalyst is dried and calcined to remove the volatile components within the solution, depositing the metal on the surface of the catalyst support. The concentration profile of the impregnated material depends on the mass transfer conditions within the pores during impregnation and drying.

The support particles are typically dry enough to absorb substantially all of the solution to form a moist solid. Aqueous solutions of water-soluble compounds or complexes of the active metal are typically utilized, such as rhodium chloride, rhodium nitrate (e.g., Ru(NO)3 and salts thereof), rhodium acetate, or combinations thereof where rhodium is the active metal and palladium nitrate, palladium tetra amine, palladium acetate, or combinations thereof where palladium is the active metal. Following treatment of the support particles with the active metal solution, the particles are dried, such as by heat treating the particles at elevated temperature (e.g., 100-150° C.) for a period of time (e.g., 1-3 hours), and then calcined to convert the active metal to a more catalytically active form. An exemplary calcination process involves heat treatment in air at a temperature of about 400-550° C. for 10 min to 3 hours. The above process can be repeated as needed to reach the desired level of active metal impregnation.

### Substrate Coating:

The above-noted catalyst compositions are typically prepared in the form of catalyst particles as noted above. These catalyst particles are mixed with water to form a slurry for purposes of coating a catalyst substrate, such as a honeycomb-type substrate. In addition to the catalyst particles, the slurry may optionally contain a binder in the form of alumina, silica, zirconium acetate, zirconia, or zirconium hydroxide, associative thickeners, and/or surfactants (including anionic, cationic, non-ionic or amphoteric surfactants). Other exemplary binders include boehmite, gamma-alumina, or delta/theta alumina, as well as silica sol. When present, the binder is typically used in an amount of about 1.0-5.0 wt. % of the total washcoat loading. Addition of acidic or basic species to the slurry is carried out to adjust the pH accordingly. For example, in some embodiments, the pH of the slurry is adjusted by the addition of ammonium hydroxide, aqueous nitric acid, or acetic acid. A typical pH range for the slurry is about 3.0 to 12.

The slurry can be milled to reduce the particle size and enhance particle mixing. The milling is accomplished in a ball mill, continuous mill, or other similar equipment, and the solids content of the slurry may be, e.g., about 20-60 wt. %, more particularly about 20-40 wt. %. In one embodiment, the post-milling slurry is characterized by a D90 particle size of about 3.0 to about 40 microns, preferably 10 to about 30 microns, more preferably about 10 to about 15 microns. The D₉₀ is determined using a dedicated particle size analyzer. The equipment employed in this example uses laser diffraction to measure particle sizes in small volume slurry. The D₉₀, typically with units of microns, means 90% of the particles by number have a diameter less than that value.

The slurry is coated on the catalyst substrate using any washcoat technique known in the art. In one embodiment, the catalyst substrate is dipped one or more times in the slurry or otherwise coated with the slurry. Thereafter, the coated substrate is dried at an elevated temperature (e.g., 100-150° C.) for a period (e.g., 10 min-3.0 hours) and then calcined by heating, e.g., at 400-700° C., typically for about 10 minutes to about 3 hours. Following drying and calcining, the final washcoat coating layer is viewed as essentially solvent-free. After calcining, the catalyst loading obtained by the above described washcoat technique can be determined through calculation of the difference in coated and uncoated weights of the substrate. As will be apparent to those of skill in the art, the catalyst loading can be modified by altering the slurry rheology. In addition, the coating/drying/calcining process to generate a washcoat can be repeated as needed to build the coating to the desired loading level or thickness, meaning more than one washcoat may be applied.

In certain embodiments, the coated substrate is aged, by subjecting the coated substrate to heat treatment. In one embodiment, aging is done at a temperature of about 850° C. to about 1050° C. in an environment of 10 vol. % water in an alternating hydrocarbon/air feed for 50-75 hours. Aged catalyst articles are thus provided in certain embodiments. In certain embodiments, particularly effective materials comprise metal oxide-based supports (including, but not limited to substantially 100% ceria supports) that maintain a high percentage (e.g., about 95-100%) of their pore volumes upon aging (e.g., at about 850° C. to about 1050° C., 10 vol. % water in an alternating hydrocarbon/air feed, 50-75 hours aging).

### Emission Treatment System:

In another aspect of the present invention, there is also provided an exhaust gas treatment system for internal combustion engines, said system comprising the catalytic article described hereinabove. In one illustration, the system comprises a platinum group metal based three-way conversion (TWC) catalytic article and the catalytic article according to the presently claimed invention, wherein the platinum group metal based three-way conversion (TWC) catalytic article is positioned downstream from an internal combustion engine is in fluid communication with the engine out exhaust gas. The catalytic article of the invention can also be used as part of an integrated exhaust system comprising one or more additional components for the treatment of exhaust gas emissions.

For example, the exhaust system also known as emission treatment system may further comprise close coupled TWC catalyst, underfloor catalyst, catalysed soot filter (CSF) component, and/or a selective catalytic reduction (SCR) catalytic article. The preceding list of components is merely illustrative and should not be taken as limiting the scope of the invention.

The catalytic article may be placed in a close-coupled position. Close-coupled catalysts are placed close to an engine to enable them to reach reaction temperatures as soon as possible. In general, the close-coupled catalyst is placed within three feet, more specifically, within one foot of the engine, and even more specifically, less than six inches from the engine. Close-coupled catalysts are often attached directly to the exhaust gas manifold. Due to their proximity to the engine, close-coupled catalysts are required to be stable at high temperatures.

In another aspect of the present invention, there is also provided a method of treating a gaseous exhaust stream comprising hydrocarbons, carbon monoxide, nitrogen oxide and particulates, the method comprising contacting said exhaust stream with the catalytic article, or the exhaust gas treatment system according to the presently claimed invention.

There is also provided a method of reducing hydrocarbons, carbon monoxide, and nitrogen oxide levels in a gaseous exhaust stream, the method comprising contacting the gaseous exhaust stream with the catalytic article or the exhaust gas treatment system according to the presently claimed invention to reduce the levels of hydrocarbons, carbon monoxide, and nitrogen oxide in the exhaust gas.

In another aspect of the present invention, there is also provided use of the catalytic article or the exhaust gas treatment system according to the presently claimed invention for purifying a gaseous exhaust stream comprising hydrocarbons, carbon monoxide, and nitrogen oxide.

The invention is further described by the following embodiments. The features of each of the embodiments are combinable with any of the other embodiments where appropriate and practical.

### Embodiment 1

The catalyst composition according to the presently claimed invention comprises at least one platinum group metal; and at least one complex metal oxide, wherein the at least one platinum group metal is supported on complex metal oxide, wherein the complex metal oxide comprises ceria (calculated as CeO₂) in an amount of 50 to 99 wt. %, based on the total weight of the complex metal oxide; and zirconia (calculated as ZrO₂) in an amount of 1.0 to 50 wt. %, based on the total weight of the complex metal oxide.

### Embodiment 2

The catalyst composition according to the presently claimed invention comprises at least one platinum group metal; and at least one complex metal oxide, wherein the complex metal oxide comprises ceria (calculated as CeO₂) in an amount of 50 to 95 wt. %, based on the total weight of the complex metal oxide; and zirconia (calculated as ZrO₂) in an amount of 5.0 to 50 wt. %, based on the total weight of the complex metal.

### Embodiment 3

The catalyst composition according to the presently claimed invention comprises at least one platinum group metal; and at least one complex metal oxide, wherein the at least one platinum group metal is supported on the complex metal oxide, wherein the complex metal oxide comprises ceria (calculated as CeO₂) in an amount of 70 wt. %, based on the total weight of the complex metal oxide; and zirconia (calculated as ZrO₂) in an amount of 30 wt. %, based on the total weight of the complex metal oxide.

### Embodiment 4

The catalyst composition according to the presently claimed invention, wherein the total amount of the platinum group metal supported on the complex metal oxide is in the range from 0.1 to 10 wt. % with respect to the total weight of the complex metal oxide.

### Embodiment 5

The catalyst composition according to the presently claimed invention comprises at least one platinum group metal; and at least one complex metal oxide, wherein the at least one platinum group metal is supported on the complex metal oxide, wherein the complex metal oxide comprises ceria (calculated as CeO₂) in an amount of 50 to 99 wt. %, based on the total weight of the complex metal oxide; and zirconia (calculated as ZrO₂) in an amount of 1.0 to 50 wt. %, based on the total weight of the complex metal oxide, wherein the amount of the platinum group metal is in the range from 0.1 to 10 wt. % with respect to the total weight of the complex metal oxide.

### Embodiment 6

The catalyst composition according to the presently claimed invention comprises at least one platinum group metal; and at least one complex metal oxide, wherein the at least one platinum group metal is supported on the complex metal oxide, wherein the complex metal oxide comprises ceria (calculated as CeO₂) in an amount of 50 to 90 wt. %, based on the total weight of the complex metal oxide; and zirconia (calculated as ZrO₂) in an amount of 5.0 to 40 wt. %, based on the total weight of the complex metal oxide, wherein the platinum group metal is platinum, wherein the amount of the platinum group metal is in the range from 0.1 to 5.0 wt. % with respect to the total weight of the complex metal oxide.

### Embodiment 7

The catalyst composition according to the presently claimed invention comprises at least one platinum group metal; and at least one complex metal oxide, wherein the at least one platinum group metal is supported on the complex metal oxide, wherein the complex metal oxide comprises ceria (calculated as CeO₂) in an amount of 70 wt. %, based on the total weight of the complex metal oxide; and zirconia (calculated as ZrO₂) in an amount of 30 wt. %, based on the total weight of the complex metal oxide, wherein the platinum group metal is platinum, wherein the amount of the platinum group metal is in the range from 0.1 to 10.0 wt. % with respect to the total weight of the complex metal oxide.

### Embodiment 8

The catalyst composition according to the presently claimed invention comprises at least one platinum group metal; and at least one complex metal oxide, wherein the at least one platinum group metal is supported on the complex metal oxide, wherein the complex metal oxide comprises ceria (calculated as CeO₂) in an amount of 70 wt. %, based on the total weight of the complex metal oxide; and zirconia (calculated as ZrO₂) in an amount of 30 wt. %, based on the total weight of the complex metal oxide, wherein the platinum group metal is platinum, wherein the amount of the platinum group metal is in the range from 0.1 to 4.0 wt. % with respect to the total weight of the complex metal oxide.

### Embodiment 9

The catalyst composition according to any of the embodiments 1 to 8, wherein the complex metal oxide has a single phase of cubic fluorite crystal structure.

### Embodiment 10

The catalyst composition according to any of the embodiments 1 to 9, wherein the platinum group metal is selected from platinum, palladium, rhodium, or combinations thereof.

### Embodiment 11

The catalyst composition according to any of the embodiments 1 to 10, wherein the platinum group metal is platinum.

### Embodiment 12

The catalyst composition according to any of the embodiments 1 to 10, wherein the platinum group metal is palladium.

### Embodiment 13

The catalyst composition according to any of the embodiments 1 to 10, wherein the platinum group metal is rhodium.

### Embodiment 14

The catalyst composition according to any of the embodiments 1 to 13, wherein the complex metal oxide comprises a dopant selected from lanthana, titania, hafnia, magnesia, calcia, strontia, baria, yttrium, hafnium, praseodymium, neodymium, or any combinations thereof.

### Embodiment 15

The catalyst composition according to any of the embodiments 1 to 14, wherein the complex metal oxide component has an oxygen storage capacity of at least 150 μmole at about 350° C., and at least 300 μmole at about 450° C., after a lean and rich aging at a temperature above at least 900° C., wherein the amount of the platinum group metal supported on the complex metal oxide is at least about 0.1 wt. % to 5.0 wt. %, based on the total weight of the complex metal oxide, wherein the platinum group metal is platinum or palladium.

### Embodiment 16

The catalyst composition according to any of the embodiments 1 to 14, wherein the complex metal oxide has an oxygen storage capacity of at least 150 μmole at about 350° C., and at least 300 μmole at about 450° C., after a lean and rich aging at a temperature above at least 900° C., wherein the amount of the platinum group metal supported on the complex metal oxide is at least about 0.1 wt. % to 5 wt. %, based on the total weight of the complex metal oxide, wherein the platinum group metal is rhodium.

### Embodiment 17

The catalyst composition according to any of the embodiments 1 to 16, wherein the composition further comprises an additional platinum group metal and at least one refractory metal oxide support selected from alumina, silica, lanthana, titania, zirconia, or any combinations thereof as a support for the platinum group metal.

### Embodiment 18

The catalyst composition according to any of the embodiments 1 to 17, wherein the refractory metal oxide support optionally comprises a dopant selected from lanthana, titania, zirconia, silica, hafnia, magnesia, calcia, strontia, baria, yttrium, hafnium, praseodymium, neodymium, or any combinations thereof.

### Embodiment 19

The catalyst composition according to any of the embodiments 1 to 18, wherein the platinum group metal is thermally or chemically fixed to the complex metal oxide.

### Embodiment 20

The catalytic article according to the presently claimed invention comprising:
a. a catalyst; and
b. a substrate,
wherein the catalyst composition is deposited on at least parts of the substrate,
wherein the catalyst composition comprises at least one platinum group metal; and at least one complex metal oxide, wherein the at least one platinum group metal is supported on the complex metal oxide, wherein the complex metal oxide comprises ceria (calculated as CeO₂) in an amount of 50 to 99 wt. %, based on the total weight of the complex metal oxide; and zirconia (calculated as ZrO₂) in an amount of 1.0 to 50 wt. %, based on the total weight of the complex metal oxide.

### Embodiment 21

The catalytic article according to the presently claimed invention comprises the catalyst composition according to any of the embodiments 1 to 19.

### Embodiment 22

The catalytic article according to the presently claimed invention is a single layered catalytic article and exhibits hydrothermal stability at an aging temperature above 900° C.

### Embodiment 23

The catalytic article according to the presently claimed invention is a bi-layered article comprising:
a) a first layer; and
b) a second layer,
   wherein the first layer is deposited on at least parts of the substrate and the second layer is deposited on at least part of the first layer and/or at least part of the substrate,
wherein the first layer comprises platinum and a complex metal oxide, wherein platinum is supported on the complex metal oxide, wherein the complex metal oxide comprises ceria (calculated as CeO₂) in an amount of 50 to 99 wt. %, based on the total weight of the complex metal oxide; and zirconia (calculated as ZrO₂) in an amount of 1.0 to 50 wt. %, based on the total weight of the complex metal oxide,
wherein the second layer comprises rhodium supported on a complex metal oxide, wherein the complex metal oxide comprises ceria (calculated as CeO₂) in an amount of 50 to 99 wt. %, based on the total weight of the complex metal oxide; and zirconia (calculated as ZrO₂) in an amount of 1.0 to 50 wt. %, based on the total weight of the complex metal oxide.

### Embodiment 24

The catalytic article according to the presently claimed invention is a single layered article having a zoned configuration comprising a first zone, a second zone, a third zone or a combination thereof, wherein the first zone, second zone, third zone or combination thereof comprises the catalyst composition according to any of the embodiments 1 to 19.

### Embodiment 25

The catalytic article according to the presently claimed invention is a bi-layered article comprising a first layer deposited on a substrate and a second layer deposited on the first layer, wherein the first layer comprises a first zone and a second zone, wherein the first and/or the second zone comprises the catalyst composition according to any of the embodiments 1 to 19.

### Embodiment 26

The catalytic article according to the presently claimed invention is a bi-layered article comprising a first layer deposited on a substrate and a second layer deposited on the first layer, wherein the second layer comprises a first zone and a second zone, wherein the first and/or the second zone comprises the catalyst composition according to any of the embodiments 1 to 19.

### Embodiment 27

The catalytic article according to the presently claimed invention is a bi-layered article comprising a first layer deposited on a substrate and a second layer deposited on the first layer, wherein each of the first layer and second layer comprises a first zone and a second zone, wherein the first and/or the second zone comprises the catalyst composition according to any of the embodiments 1 to 19.

### Embodiment 28

The catalytic article according to the presently claimed invention, wherein the portion of the first zone and/or the second zone and/or the third zone is 10 to 100% of the axial length of substrate.

### Embodiment 29

The catalytic article according to the presently claimed invention, wherein the substrate is selected from a ceramic substrate, a metal substrate, a ceramic foam substrate, a polymer foam substrate, or a woven fibre substrate.

### Embodiment 30

The process for the preparation of the catalyst composition according to any of the embodiments 1 to 19, wherein said process comprises:
preparing a slurry comprising a platinum group metal supported on the complex metal oxide and optionally on a refractory metal oxide support, water, a pH control agent, and a binder; and
calcining the slurry at a temperature ranging from 400 to 700° C. to obtain the catalyst composition,
wherein the step of preparing the slurry comprises a technique selected from incipient wetness impregnation, incipient wetness co-impregnation, and post-addition to support the platinum group metal on the complex metal oxide.

### Embodiment 31

The process according to the presently claimed invention, wherein the pH control agent is selected from carboxylic acid, acetic acid, nitric acid, sulfuric acid, ammonia hydroxide or any combination thereof.

### Embodiment 32

The process according to the presently claimed invention, wherein the binder is selected from surfactants, colloidal powders made from alumina; zirconia; silica; titania, or polymers.

### Embodiment 33

The process for the preparation of the catalytic article according to the presently claimed invention, wherein said process comprises:
preparing a slurry comprising a platinum group metal supported on the complex metal oxide and optionally on a refractory metal oxide support, water, a pH control agent, and a binder; and
depositing the slurry on the substrate followed by calcining at a temperature ranging from 400 to 700° C. to obtain the catalytic article.

### Embodiment 34

The for the preparation of the catalytic article according to the presently claimed invention, wherein said process comprises:
preparing a first slurry comprising platinum or palladium supported on the complex metal oxide and optionally on a refractory metal oxide support, water, a pH control agent, and a binder; and
depositing the first slurry on the substrate to obtain a first layer followed by calcining at a temperature ranging from 400 to 700° C.;
preparing a second slurry comprising rhodium supported on the complex metal oxide and optionally on a refractory metal oxide support, water, a pH control agent, and a binder catalytic article; and
depositing the second slurry on the first layer to obtain a second layer followed by calcining at a temperature ranging from 400 to 700° C.

### Embodiment 35

The exhaust gas treatment system for internal combustion engines, said system comprising the catalytic article according to any of the embodiments 20-29.

### Embodiment 36

The exhaust gas treatment system according to embodiment 35, wherein said system comprises a platinum group metal based three-way conversion (TWC) catalytic article and the catalytic article according to any of the embodiments 20 to 29, wherein the platinum group metal based three-way conversion (TWC) catalytic article is positioned downstream from an internal combustion engine is in fluid communication with the engine out exhaust gas.

### Embodiment 37

The method of treating a gaseous exhaust stream comprising hydrocarbons, carbon monoxide, nitrogen oxide and particulates, the method comprising contacting said exhaust stream with the catalytic article according to any of the embodiments 20 to 29, or the exhaust gas treatment system according to any of the embodiments 35 to 36.

### Embodiment 38

The method of reducing hydrocarbons, carbon monoxide, and nitrogen oxide levels in a gaseous exhaust stream, the method comprising contacting the gaseous exhaust stream with the catalytic article according to any of the embodiments 20 to 29 or the exhaust gas treatment system according to any of the embodiments 35 to 36 to reduce the levels of hydrocarbons, carbon monoxide, and nitrogen oxide in the exhaust gas.

### Embodiment 39

The use of the catalytic article according to any of the embodiments 20 to 29 or the exhaust gas treatment system according to any of the embodiments 35 to 36 for purifying a gaseous exhaust stream comprising hydrocarbons, carbon monoxide, and nitrogen oxide.

Aspects of the presently claimed invention are more fully illustrated by the following examples, which are set forth to illustrate certain aspects of the present invention and are not to be construed as limiting thereof.

### Example 1A: Reference Catalyst Composition a (Comparative Sample A)

### 0.5% Pt on Low Ce-Content Ce/Zr-Containing Support (Sample Preparation):

A measured amount (0.07 gm) of platinum ethanolamine was impregnated onto 2.8 gram of the complex metal oxide (40 wt. % CeO₂, 50 wt. % ZrO₂, and 5.0 wt. % each of LaO₃ and Pr₂O₃), resulting in a coated powder with 0.5 wt. % Pt. The complex metal oxide can be prepared by co-precipitation of metal salts or by impregnation of various salts onto the base support. The Pt impregnated powder was placed in deionized water (solid content 30 wt. %). The slurry was milled to a particle size with D₉₀ less than 15 μm using a ball mill. The milled slurry was dried at 120° C. under stirring and calcined at 550° C. for 2.0 hours in air. The calcined sample was cooled in air until reaching room temperature.

The calcined powder was crushed and sieved to a particle size of 250-500 μm. The sieved powder was aged in an oven (box furnace) at 980° C. for 5.0 hours in a gas flow consisting 10% steam. After heating-up (5K/min) in steam/air till the temperature reaches 980° C., the gas flow was then switched between steam/air (10 min) and steam/forming gas (4% H₂ in N₂, 10 min). Cool-down was performed in steam/air, when the temperature drops below 450° C., steam dosing was switched off and the sample was cooled to room temperature in dry air.

### Example 1B: Reference Catalyst Composition B (Comparative Sample B)

### 1.0% Pt on Low Ce-Content Ce/Zr-Containing Support (Sample Preparation):

The process of example 1 was repeated for example 1B, except that the Pt loading on the support was 1.0 wt. %.

### Example 1C: Reference Catalyst Composition C (Comparative Sample C)

1.0% Pt on ceria support (sample preparation): The process of example 2 was repeated for example 1C, except that the support used was ceria.

### Example 1D: Reference Catalyst Composition D (Comparative Sample D)

1.0% Pt on low Ce-content alumina support (sample preparation): The process of Example 2 was repeated for Example 1D, except that the support used was Ce/Al with the ceria concentration on the alumina was 8.0 wt. %.

### Example 5: Reference Catalyst Composition E (Comparative Sample E)

1.0% Pt on alumina support (sample preparation): The process of example 2 was repeated for example 5, except that the support used was gamma-alumina only.

### Example 2A: Invention Catalyst Composition 2A

0.5% Pt on high Ce-content Ce/Zr-containing support (sample preparation): The preparation procedure was as per Example 1A, except that the high Ce-content Ce/Zr-containing support (70 wt. % CeO₂, 30 wt. % ZrO₂) was used as Pt support.

### Example 2B: Invention Catalyst Composition 2B

1.0% Pt on high Ce-content Ce/Zr-containing support (sample preparation): The process of Example 2 Å was repeated, except that the Pt-content on the support was 1.0 wt. %.

### Example 2C: Invention Catalyst Composition 2C

1.0% Pt on high Ce-content Ce/Zr-containing support (sample preparation): The process of example 2 Å was repeated, except that the Ce/Zr-containing support with 58 wt. % CeO₂ and 42 wt. % ZrO₂ was used as Pt support.

### Example 3: Reactor Testing of the Powder Samples

### A: Oxygen Storage Capacity

For testing the oxygen storage capacity (OSC), about 100 mg of the respective shaped samples were diluted to a volume of 1.0 mL using corundum of the same particle size fraction and placed in a reactor which was heated to 450° C. The materials were then exposed to alternating pulses of nitrogen gas containing 1.0 vol. % oxygen (“lean”) and nitrogen gas containing 2.0 vol. % of carbon monoxide (“rich”) at a gas hourly space velocity (GHSV) of 60,000 h-1. The amount of CO₂ formed during the rich phase was recorded with a mass spectrometer (Pfeiffer Quadstar) with a frequency of 1.0 Hz. A total of 15 cycles with a lean and rich duration of 10 s each were used. The same procedure was also applied at 350° C. For sample ranking, the oxygen storage capacity measured in the 15 cycles (10 s each cycle) was averaged and normalized to the amount of tested material (i.e. μmol (CO₂) formed per g of the material). The amount of CO₂ formed is equivalent to the amount of oxygen atoms released from the oxides during the rich phase.

Results, shown in Tables 1 and 1a, indicate that the inventive catalyst compositions with 0.5 and 1.0% Pt offer about 3 times more OSC at 450° C. compared to the other catalyst compositions.

It is found that the complex metal oxide containing high amount of ceria exhibits an ability of moving more oxygen atoms within their lattice crystal structure freely due to the vacancy created by the zirconium insertion.

TABLE 1
OSC measurements of various supports @450°
C., with 0.5% and 1.0% Pt loading

| Oxygen Storage Capacity | | | Ce-content |
|---|---|---|---|
| Measurement | | | in the |
| CO₂ μmole/g | 0.5% Pt | 1.0% Pt | support, % |
| Example 1A | 137 | — | 40 |
| Example 1B | — | 165 | 40 |
| Example 1C | — | 124 | 100 |
| Example 1D | — | 82 | 8 |
| Example 1E | — | 32 | 0 |
| Example 2A | 479 | — | 70 |
| Example 2B | — | 505 | 70 |
| Example 2C | — | 657 | 58 |

TABLE 2
OSC measurements of various supports @350°
C., with 0.5% and 1.0% Pt loading

| Oxygen Storage Capacity | | | Ce-content |
|---|---|---|---|
| Measurement | | | in the |
| CO₂ μmole/g | 0.5% Pt | 1.0% Pt | support, % |
| Example 1A | 31 | — | 40 |
| Example 1B | — | 43 | 40 |
| Example 1C | — | 149 | 100 |
| Example 1D | — | 119 | 8 |
| Example 1E | — | 45 | 0 |
| Example 2A | 209 | — | 70 |
| Example 2B | — | 215 | 70 |
| Example 2C | — | 391 | 58 |

### Examples 5-8

The examples 5-8 were prepared using Pd instead of Pt as a PGM. The examples 6-8 showed superior OSC, at 0.5% and 1.0% Pd loading, at 450° C. The results are shown in Table 3.

TABLE 3
OSC measurements of various supports @450°
C., with 0.5% and 1.0% Pd loading

| Oxygen Storage Capacity | | | Ce-content |
|---|---|---|---|
| Measurement | | | in the |
| @450° C.; CO₂ μmole/g | 0.5% Pd | 1.0% Pd | support, % |
| Example 5A | 524 | — | 40 |
| Example 5B | — | 523 | 40 |
| Example 5C | — | 132 | 100 |
| Example 5D | — | 28 | 8 |
| Example 5E | — | 0 | 0 |
| Example 6 | 583 | — | 70 |
| Example 7 | — | 615 | 70 |
| Example 8 | 542 | — | 58 |

The advantages of using the inventive catalyst composition can also be observed in some extreme driving conditions such as during the fuel-cut and the engine cylinder re-activation periods (stop-and-go) when the exhaust gas temperatures are relatively cooler, often at 300° C. to 400° C. range. High OSCs are needed to handle such situations, even with the Pd/Rh TWC catalysts.

Table 4 shows that even at 350° C., the catalyst compositions of the present invention containing complex metal oxide comprising high ceria are still better than the traditional ceria-zirconia containing catalysts, at both 0.5% and 1% Pd loading. With its high OSC, the presently claimed Pd/Rh catalysts containing high ceria containing complex metal oxide, can able to handle fuel-cut, and engine cylinder de-activation events, better than the traditional low Ce-containing Pd/Rh TWC catalysts.

TABLE 4
OSC measurements of various supports @350°
C., with 0.5% and 1.0% Pd loading

| Oxygen Storage Capacity | | | Ce-content |
|---|---|---|---|
| Measurement | | | in the |
| @350° C.; CO₂ μmole/g | 0.5% Pd | 1.0% Pd | support, % |
| Example 5A | 170 | — | 40 |
| Example 5B | — | 173 | 40 |
| Example 5C | | 134 | 100 |
| Example 5D | | 31 | 8 |
| Example 5E | | 37 | 0 |
| Example 6 | 313 | — | 70 |
| Example 7 | — | 346 | 70 |
| Example 8 | 221 | — | 58 |

### Examples 9-11

The examples 9-11 were prepared using Rh instead of Pt as a PGM. The examples 9-12 showed superior OSC, at 0.1% and 0.3% Rh loading, at 350° C., indicating the inventive supports also works well with Rh. The results are shown in Table 5:

TABLE 5
OSC measurements of various supports @350°
C., with 0.1% and 0.3% Rh loading

| Oxygen Storage Capacity | | | Ce-content |
|---|---|---|---|
| Measurement | | | in the |
| @350° C.; CO₂ μmole/g | 0.1% Rh | 0.3% Rh | support, % |
| Example 9A | 169 | — | 40 |
| Example 9B | — | 254 | 40 |
| Example 9C | — | 131 | 100 |
| Example 9D | — | 40 | 8 |
| Example 9E | — | 49 | 0 |
| Example 10 | — | 312 | 70 |
| Example 11 | 259 | — | 58 |

### Example 12: Reactor Testing of the Powder Samples

### Light-Off Test in Simulated Gasoline Engine Exhaust

Light-off and λ-sweep tests were also performed in a parallel testing unit. About 100 mg of the respective samples were diluted to a volume of 1 mL using corundum of the same particle size fraction and placed in a reactor (stainless steel, 7 mm inner diameter). To assess catalytic performance of the materials in a three way catalytic converter, samples were exposed to a gas feed with constant flow rate and oscillating composition (is lean, is rich) at a GHSV of 70000 h-1 with a defined average λ value (i.e. ratio of actual and stoichiometric air/fuel ratio). The concentrations of feed components in the lean and rich gas are listed in Table 6, the actual λ-value was measured using a λ-sensor (Bosch, planar wide band sensor “LSU 4.9”) and adjusted by the amount of oxygen dosed in the lean and rich feed, without disturbing the amplitude of the perturbation (parameter “Δ” in the table). Individual exhaust components were measured with a frequency of 1 Hz using online gas analyzers (NO, NO₂, NH₃: ABB LIMAS; CO, CO₂, N₂O: ABB URAS; total HC: ABB FIDAS; H₂, H₂O: mass spectrometer, Pfeiffer Quadstar).

TABLE 6
Feed gas composition used in the L/O test, for the powder samples

| Gas | Lean | Rich |
|---|---|---|
| CO [%] | 0.7 | 2.33 |
| H₂ [%] | 0.22 | 0.77 |
| O₂ [%] | 1.8 ± Δ | 0.7 ± Δ |
| HC (propene:propane:iso- | 3000 | 3000 |
| octane 2:1:1) [ppm C1] | | |
| NO [ppm] | 1500 | 1500 |
| CO₂ [%] | 14 | 14 |
| H₂O [%] | 10 | 10 |

For the light-off test, the average of was adjusted to 1.00 (i.e. on average stoichiometric conditions, lean: λ=1.05, rich: λ=0.95). Then the reactor was equilibrated to several discrete temperatures (200, 225, 250, 275, 300, 325, 350, 375, 400, 425, 450, 475, 500° C.). At each temperature the exhaust of each of the parallel reactors was sequentially switched to the analysers, and each sample was exposed to the oscillating feed for 150 s equilibration time to achieve stationary conditions. Afterwards, the signal of each gas analyser was recorded for 30 s and the average value from this time interval was used to calculate conversions. To estimate light-off temperatures, the discrete values were numerically interpolated as a function of temperature and e.g. T₅₀=temperature of 50% conversion was calculated by a root finding procedure applied to the interpolated function.

Results, shown in Table 5 below, indicate that these high Ce-content complex metal oxides are useful for cold-start L/O.

TABLE 7
L/O measurements of various supports,
with 0.5% and 1% Pt loading

| | | | | Ce-content |
|---|---|---|---|---|
| HC/CO/NO | HC₇₀ | CO₅₀ | NO₅₀ | in the |
| Light-Off (L/O) | L/O, ° C. | L/O, ° C. | L/O, ° C. | support, % |
| Example 1A (0.5% Pt) | 463 | 406 | 463 | 40 |
| Example 1B (1% Pt) | 375 | 387 | 496 | 40 |
| Example 1C (1% Pt) | 375 | 368 | 400 | 100 |
| Example 1D (1% Pt) | 539 | 510 | — | 8 |
| Example 1E (1% Pt) | 504 | 488 | — | 0 |
| Example 2A (0.5% Pt) | 370 | 336 | 366 | 70 |
| Example 2B (1% Pt) | 374 | 336 | 363 | 70 |

### Example 13: Reactor Testing of the Powder Samples

### λ-Sweep Test in Simulated Gasoline Engine Exhaust

For λ-sweep tests, the temperature was set to 450 and 350° C. and the average λ-value was adjusted to 1.05, 1.02, 1.01, 1.00, 0.99, 0.98, 0.96 by adjusting the parameter Δ in the table. At each λ setpoint, all samples in the reactor were sequentially analysed (again 150 s equilibration time+30 s data acquisition). For sample ranking, the average conversion in the λ-window 1.02-0.98 was calculated for each exhaust component.

Results, shown in Tables 8 & 9 below, indicate that these high Ce-content OSMs outperform the reference samples, at high temperature (450° C.) representing highway cruising periods, and low temperature (350° C.) representing stop-and-go (fuel-cut) situations.

Specifically, at low temperature (350° C.), there is essentially no conversions (<10%) for the OSMs that have the Ce-content less than 50%, illustrating the advantages of the present materials.

TABLE 8
Average λ- Sweep results from the samples containing
Pt on various supports, at 450° C.

| Average λ- Sweep | | | | Ce-content |
|---|---|---|---|---|
| @450° C. | | | | in the |
| (from 0.98 to 1.02) | HC, % | CO, % | NO, % | support, % |
| Example 1A (0.5% Pt) | 46 | 66 | 15 | 40 |
| Example 1B (1% Pt) | 54 | 75 | 30 | 40 |
| Example 1C (1% Pt) | 95 | 98 | 66 | 100 |
| Example 1D (1% Pt) | 33 | 46 | 22 | 8 |
| Example 1E (1% Pt) | 65 | 65 | 24 | 0 |
| Example 2A (0.5% Pt) | 84 | 93 | 66 | 70 |
| Example 2B (1% Pt) | 92 | 96 | 77 | 70 |
| Example 2C (1% Pt) | 66 | 80 | 39 | 58 |

TABLE 9
Average λ- Sweep results from the samples containing
Pt on various supports, at 350° C.

| Average λ- Sweep | | | | Ce-content |
|---|---|---|---|---|
| @350° C. | | | | in the |
| (from 0.98 to 1.02) | HC, % | CO, % | NO, % | support, % |
| Example A (0.5% Pt) | 1 | 8 | 4 | 40 |
| Example B (1% Pt) | 2 | 9 | 5 | 40 |
| Example C (1% Pt) | 89 | 96 | 67 | 100 |
| Example D (1% Pt) | 4 | 17 | 5 | 8 |
| Example E (1% Pt) | 1 | 18 | 6 | 0 |
| Example 1 (0.5% Pt) | 54 | 88 | 28 | 70 |
| Example 2 (1% Pt) | 74 | 93 | 58 | 70 |
| Example 3 (1% Pt) | 36 | 73 | 15 | 58 |

### Examples 14-16: Preparation of Catalytic Articles

### Samples Preparation:

All monolith coated catalysts samples illustrated in the following examples were made with a common front catalyst (FC) with a PGM loading of 120 g/ft³ at Pt:Pd:Rh=59:59:2, followed by a rear catalyst (RC) of lower PGM loading of 12 g/ft³.

All inventive samples were prepared according to the rear catalyst PGM loading, with Pt:Pd:Rh=0:10:2 (Pd/Rh, RC), or Pt:Pd:Rh=10:0:2 (Pt/Rh, RC).

All sample preparations follow a common method as described below. Unless otherwise indicated, all parts and percentages are by weight, and all weight percentages, ratio are expressed on a dry basis, meaning excluding water content, unless otherwise indicated.

### Example 14: Reference Catalytic Article F (Comparative Sample F)

Catalyst compositions for the reference article F (comparative sample F) were prepared by impregnating support materials, a combination of a high temperature stable γ-alumina (2361 g) and a ceria-zirconia compound (40% Ce, 50% Zr with 10% La/Pr dopants, 300 g), with an aqueous solution of Palladium Nitrate (47 g). A second support material, consisting of a γ-alumina with Ba dopant (840 g), and the same ceria-zirconia compound (40% Ce, 50% Zr with 10% La/Pr dopants, 1270 g), was impregnated with an aqueous solution of Rhodium Nitrate (45 g). The above impregnation process was conducted under a continuous planetary motion of mixing until a perfectly homogeneous mix of PGM onto the support material was obtained. The semi-wet powders were free flowing for transferring into a larger container for turning into a slurry. De-ionized water and a dispersant (50 g) were first added into this large container. While the content in the container was stirred, PGM impregnated powder was gradually added to it. A small number of additives (La/Ba/Sr, 200 g) were also added into the slurry. The final pH of the slurry upon mixing was adjusted to 4.5 by use of nitric acid at a solid content of 43%. The well dispersed mixture was then loaded into a mill and the solid's particle size was reduced to D₉₀˜10 micron, followed by pH adjustment with acetic acid, if necessary.

The milled slurry was transferred into a clean container and was prepared for coating onto ceramic monolith substrates at a washcoat dry gain of 2.9 g/in³. Coated substrates were then placed into oven for drying at 120° C. for 2 hours and calcination at 500° C. for one hour.

### Example 15: Reference Article G (Comparative Sample G)

The catalytic article was prepared as per example 11, except that Pd nitrate was replaced with a Pt compound solution (prepared by a method illustrated in US2017/0304805).

### Example 16: Invention Catalytic Article H (Inventive Sample H)

The catalytic articles were prepared as per example 11, except that the ceria-zirconia compound was replaced by the complex metal oxide containing high amount of ceria of Example 2A & Example 2B.

All RC core samples were subjected to the same aging in a pulse flame reactor using isooctane as the fuel to generate exotherm. The aging, a total of 16 hours, was completed under the lean/rich perturbation protocol (4-mode) with a peak temperature at 950° C.

### Samples Testing:

To illustrate the effectiveness of Pt-activation using the inventive materials, all RC core samples were evaluated with the same FC that has a high PGM loading representing a real-world application for a 2.7 L gasoline engine platform. This FC has been severe aged in an engine dyno for 100 hours with a peak temperature at 950° C., under both hydrothermal and phosphorous exposures. The purpose of using a severe aged sample as the front catalyst (FC) is to stress the RC with all these unconverted HC/CO/NO emissions so that a strong performer can be identified.

### Example 17: Lab Reactor Core Sample Testing

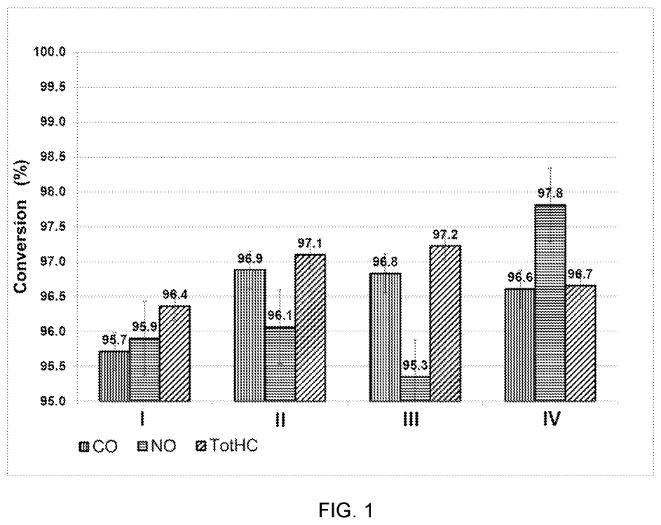

The RC cores are all at 1″ diameter and 3″ long, with a cell density at 400 cells per square inches of the cross-section areas. Evaluation was conducted in a dynamic reactor capable of simulating the real vehicle driving conditions under the FTP protocol. Using a MY2020 2.7 L engine platform trace, the FTP results for the aged samples were shown in FIG. 1.

FIG. 1 illustrates that:
1. Adding a traditional Pd/Rh RC to the Pd/Rh front reference catalyst (FC) helps CO/HC performance, but not NO.
2. Simply replacing Pd with Pt, without changing the ingredients, will not help in improving CO/HC performance, yet with a potential reduction in NO performance
3. With enhanced Pt-activation ingredients, NO performance can be enhanced significantly.

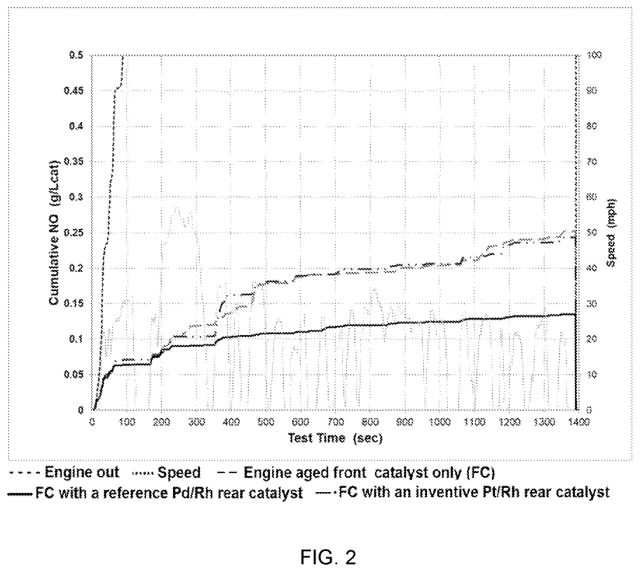

Results indicate that a Pt/Rh RC is not only feasible but can also improve NO conversion for the combined system, resulting a further NOx emission reduction (˜50%), as shown in FIG. 2, creating a potential for meeting a tighter emission regulation such as SULEV-30 or SULEV-20. The Pd/Rh RC reference catalyst, on the other hand, contribute little to NO emission reduction.

As shown in FIG. 2, the contributions of NO reduction during the cold start period are small from the RC in general, compared to the FC only system, due to its location (i.e. behind the FC, so it warms up slowly). Once it passes the second hill of FTP cycle, the contributions on NO emission reduction from the Pt/Rh RC are significant, indicating a strong Pt/Rh synergism, under the fuel cut conditions (FIG. 3). Based on the results, a replacement of Pd with Pt in RC is not only feasible, but is beneficial, if a proper ceria-zirconia containing complex metal oxide is being used.

Although the embodiments disclosed herein have been described with reference to particular embodiments it is to be understood that these embodiments are merely illustrative of the principles and applications of the presently claimed invention. It will be apparent to those skilled in the art that various modifications and variations can be made to the methods and apparatus of the presently claimed invention without departing from the spirit and scope of the presently claimed invention. Thus, it is intended that the presently claimed invention include modifications and variations that are within the scope of the appended claims and their equivalents, and the above-described embodiments are presented for purposes of illustration and not of limitation. All patents and publications cited herein are incorporated by reference herein for the specific teachings thereof as noted, unless other statements of incorporation are specifically provided.

1.-34. (canceled)

35. A catalyst composition comprising:
a) at least one platinum group metal; and
b) at least one complex metal oxide,
wherein the at least one platinum group metal is supported on the complex metal oxide,
wherein the complex metal oxide comprises:
i) ceria (calculated as CeO₂) in an amount of about 50 to about 99 wt. %, based on the total weight of the complex metal oxide; and
ii) zirconia (calculated as ZrO₂) in an amount of about 1.0 to about 50 wt. %, based on the total weight the complex metal oxide.

36. The catalyst composition according to claim 35, wherein the platinum group metal is selected from platinum, palladium, rhodium or combinations thereof.

37. The catalyst composition according to claim 35, wherein the complex metal oxide comprises ceria (calculated as CeO₂) in an amount of 70 wt. %, based on the total weight of the complex metal oxide; and zirconia (calculated as ZrO₂) in an amount of 30 wt. %, based on the total weight of the complex metal oxide.

38. The catalyst composition according to claim 35, wherein the complex metal oxide has a single phase of cubic fluorite crystal structure.

39. The catalyst composition according to claim 35, wherein the total amount of the platinum group metal supported on the complex metal oxide is in the range from 0.1 to 10 wt. % with respect to the total weight of the complex metal oxide.

40. The catalyst composition according to claim 35, wherein the platinum group metal is platinum or palladium or rhodium.

41. The catalyst composition according to claim 35, wherein the complex metal oxide comprises a dopant selected from lanthana, titania, hafnia, magnesia, calcia, strontia, baria, yttrium, hafnium, praseodymium, neodymium or any combinations thereof.

42. The catalyst composition according to claim 35, wherein the complex metal oxide has an oxygen storage capacity of at least 150 μmole at about 350° C., and at least 300 μmole at about 450° C., after a lean and rich aging at a temperature above at least 900° C., wherein the amount of the platinum group metal supported on the complex metal oxide is at least about 0.1 wt. %, based on the total weight of the complex metal oxide, wherein the platinum group metal is platinum or palladium or rhodium.

43. The catalyst composition according to claim 35, wherein the composition further comprises an additional platinum group metal and at least one refractory metal oxide selected from alumina, silica, lanthana, titania, zirconia, or any combinations thereof.

44. The catalyst composition according to claim 43, wherein the refractory metal oxide optionally comprises a dopant selected from lanthana, titania, silica, hafnia, magnesia, calcia, strontia, baria, yttrium, hafnium, praseodymium, neodymium or any combinations thereof.

45. The catalyst composition according to claim 35, wherein the platinum group metal is thermally or chemically fixed to the complex metal oxide.

46. A catalytic article comprising:
a) the catalyst composition according to claim 35; and
b) a substrate,
wherein the catalyst composition is deposited on at least parts of the substrate.

47. The catalytic article according to claim 46, wherein the catalytic article is a single layered catalytic article and exhibits hydrothermal stability at an aging temperature above 900° C.

48. The catalytic article according to claim 46, wherein the catalytic article is a bi-layered article comprising:
a) a first layer; and
b) a second layer,
wherein the first layer is deposited on at least parts of the substrate and the second layer is deposited on at least parts of the first layer and/or at least on parts of the substrate,
wherein the first layer comprises platinum and a complex metal oxide, wherein platinum is supported on the complex metal oxide, wherein the complex metal oxide comprises ceria (calculated as CeO₂) in an amount of 50 to 99 wt. %, based on the total weight of the complex metal oxide; and zirconia (calculated as ZrO₂) in an amount of 1.0 to 50 wt. % %, based on the total weight of the complex metal oxide,
wherein the second layer comprises rhodium supported on a complex metal oxide, wherein the complex metal oxide comprises ceria (calculated as CeO₂) in an amount of 50 to 99 wt. %, based on the total weight of the complex metal oxide; and zirconia (calculated as ZrO₂) in an amount of 1.0 to 50 wt. % %, based on the total weight of the complex metal oxide

49. The catalytic article according to claim 46, wherein the catalytic article is a single layered article having a zoned configuration comprising a first zone, a second zone, a third zone or a combination thereof, wherein the first zone, second zone, third zone or combination thereof comprises the catalyst composition.

50. The catalytic article according to claim 46, wherein the catalytic article is a bi-layered article comprising a first layer deposited on the substrate and a second layer deposited on the first layer, wherein the first layer and/or second layer comprises a first zone and a second zone, wherein the first and/or the second zone comprises the catalyst composition.

51. The catalytic article according to claim 46, wherein the substrate is selected from a ceramic substrate, a metal substrate, a ceramic foam substrate, a polymer foam substrate or a woven fibre substrate.

52. A process for the preparation of the catalyst composition according to claim 35, wherein said process comprises:
preparing a slurry comprising a platinum group metal supported on the complex metal oxide and optionally on a refractory metal oxide support, water, a pH control agent and a binder; and
calcining the slurry at a temperature ranging from 400 to 700° C. to obtain the catalyst composition,
wherein the step of preparing the slurry comprises a technique selected from incipient wetness impregnation, incipient wetness co-impregnation, and post-addition to support the platinum group metal on the complex metal oxide.

53. The process according to claim 52, wherein the pH control agent is selected from carboxylic acid, acetic acid, nitric acid, sulfuric acid, ammonia hydroxide or any combination thereof.

54. The process according to claim 52, wherein the binder is selected from surfactants, colloidal powders made from alumina; zirconia; silica; titania, or polymers.

55. A process for the preparation of the catalytic article according to claim 46, wherein said process comprises:
preparing a slurry comprising a platinum group metal supported on the complex metal oxide and optionally on a refractory metal oxide support, water, a pH control agent and a binder; and
depositing the slurry on the substrate followed by calcining at a temperature ranging from 400 to 700° C. to obtain the catalytic article.

56. A process for the preparation of the catalytic article according to claim 50, wherein said process comprises:
preparing a first slurry comprising platinum or palladium supported on the complex metal oxide and optionally on a refractory metal oxide support, water, a pH control agent and a binder; and
depositing the first slurry on the substrate to obtain a first layer followed by calcining at a temperature ranging from 400 to 700° C.;
preparing a second slurry comprising rhodium supported on the complex metal oxide and optionally on a refractory metal oxide support, water, a pH control agent and a binder catalytic article; and
depositing the second slurry on the first layer to obtain a second layer followed by calcining at a temperature ranging from 400 to 700° C.

57. An exhaust gas treatment system for internal combustion engines, said system comprising the catalytic article according to claim 46.

58. The exhaust gas treatment system according to claim 57, wherein said system comprises a platinum group metal based three-way conversion (TWC) catalytic article and the catalytic article, wherein the platinum group metal based three-way conversion (TWC) catalytic article is positioned downstream from an internal combustion engine is in fluid communication with the engine out exhaust gas.

59. A method of reducing hydrocarbons, carbon monoxide, and nitrogen oxide levels in a gaseous exhaust stream, the method comprising contacting the gaseous exhaust stream with the catalytic article according to claim 46 to reduce the levels of hydrocarbons, carbon monoxide, and nitrogen oxide in the exhaust gas.

60. A method of reducing hydrocarbons, carbon monoxide, and nitrogen oxide levels in a gaseous exhaust stream, the method comprising contacting the gaseous exhaust stream with the exhaust gas treatment system according to claim 57 to reduce the levels of hydrocarbons, carbon monoxide, and nitrogen oxide in the exhaust gas.
